(19) United States
(12) Patent Application Publication
(10) Pub. No.: US 2006/0133067 A1
(43) Pub. Date: Jun. 22, 2006

(54) Shoe with an illuminating heel

(76) Inventor: Cheng-Yang Tsai, Taichung (TW)

Correspondence Address: HERSHKOVITZ & ASSOCIATES, 1725 I STREET NW, SUITE 300, WASHINGTON, DC, 20006, US

(21) Appl. No.: 11/017,693

(22) Filed: Dec. 22, 2004

(51) Int. Cl. F21V 21/00

(52) U.S. Cl. 362/103; 362/249

(57) ABSTRACT

A shoe with an illuminating heel has a shoe body with a shank and a heel, an illuminating device, a switch device and a wire. The heel is made of transparent material, and the illuminating device is mounted inside the heel. The switch device is attached to the shank under the shoe body, and the wire electrically connects the switch device to the illuminating device. By separating the switch device from the illuminating device, the heel can be diminished in diameter to be made thin.

### BACKGROUND OF THE INVENTION

1. Field of the Invention

The present invention relates to a shoe, and more particularly to a shoe with an illuminating heel that can present different illuminating effects.

2. Description of Related Art

Shoes not only protect feet, but also provide a decorative effect. Therefore, shoes are always designed to have different appearances to accommodate preferences of different people and to make people more attractive. By adding illuminating lights to shoes, the shoes are particularly attractive in the dark. With reference to FIGS. 4 and 5, a conventional shoe having an illuminating heel is composed of a shoe with a heel body (50) and an illumination assembly (not numbered).

The heel body (50) is made of transparent material to allow light to emit from inside and has a side surface (not numbered), a cavity (52) and a cover (58). The cavity (52) is formed in the heel body (50) through a side surface and has an outer opening (not numbered). The cover (58) is mounted in the outer opening to close the cavity (52) and has multiple screws (not numbered). The screws extend through the cover (58) and screw into the heel body (50) to hold the cover (58) in the opening of the cavity (52).

The illumination assembly is composed of a circuit board (54), an integrated circuit (IC), multiple illuminating elements (542), a power source (544), a switch (548) and a pushbutton (549). The circuit board (54) is mounted inside the cavity (52) in the body (50) and has a top face (not numbered), bottom face (not numbered) and a printed circuit. The printed circuit is formed on the bottom face of the circuit board (54), and the integrated circuit is mounted on the bottom face of the circuit board (54) and is connected to the printed circuit. The illuminating elements (542) are mounted on the bottom face of the circuit board (54), are connected to the printed circuit and are controlled by the integrated circuit. The power source (544) is mounted on the top face of the circuit board (54) and is connected to the integrated circuit and the illuminating elements (542) through the printed circuit to control the illuminating elements (542). The switch (548) is mounted on the circuit board (54) and connected to the integrated circuit through the printed circuit to turn on or turn off the illuminating assembly. The pushbutton (549) abuts the switch (548) and passes through the cover (58) to allow a person to press the pushbutton (549) and operate the switch (548).

Because the integrated circuit, illuminating elements (542), power source (544) and switch (548) are all mounted on the circuit board (54), the illumination assembly mounted inside the heel body (50) is bulky, and the heel body (50) is always thick and cannot be diminished in size. Design of a high heel shoe having the illumination assembly is limited.

To overcome the shortcomings, the present invention provides a shoe with an illuminating heel to obviate the aforementioned problems.

### SUMMARY OF THE INVENTION

The main objective of the invention is to provide a shoe with an illuminating heel that has a switch device and an illuminating device separate from each other. Thereby, a diameter of the illuminating heel can be greatly diminished to allow more diversified designs of the high-heel shoe.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a shoe with an illuminating heel in accordance with the present invention;

FIG. 2 is a phantom side view of the shoe and the illuminating heel in FIG. 1;

FIG. 3 is a phantom side view of another embodiment of the shoe with the illuminating heel in accordance with the present invention;

FIG. 4 is an exploded perspective view of a conventional shoe with an illuminating heel in accordance with the prior art; and

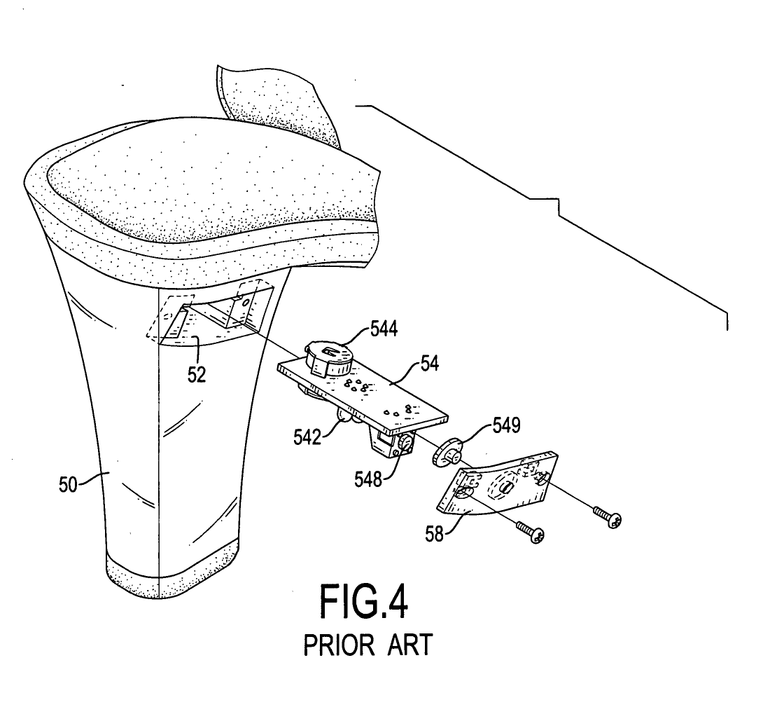

FIG. 5 is a perspective view of the conventional shoe in FIG. 4.

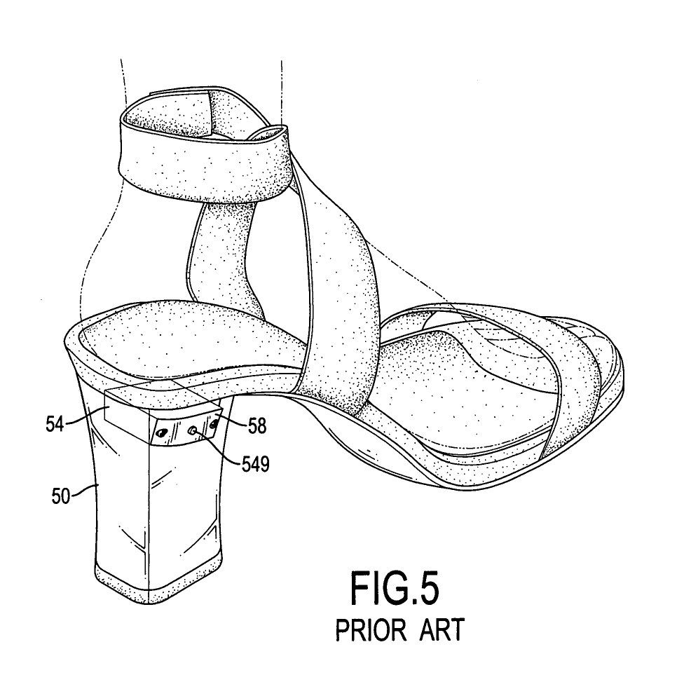

### DETAILED DESCRIPTION OF PREFERRED EMBODIMENT

A shoe with an illuminating heel in accordance with the present invention comprises a shoe body with a shank and a heel, an illuminating device, a switch device and a wire. The heel is made of transparent material, and the illuminating device is mounted inside the heel. The switch device is attached to the shank under the shoe body, and the wire electrically connects the switch device to the illuminating device. By separating the switch device from the illuminating device, the heel can be diminished in diameter to be made thin.

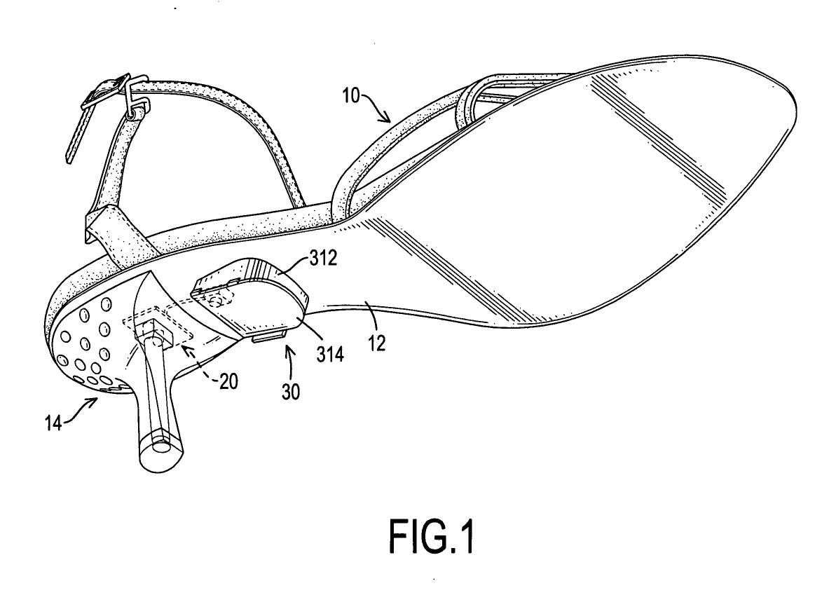

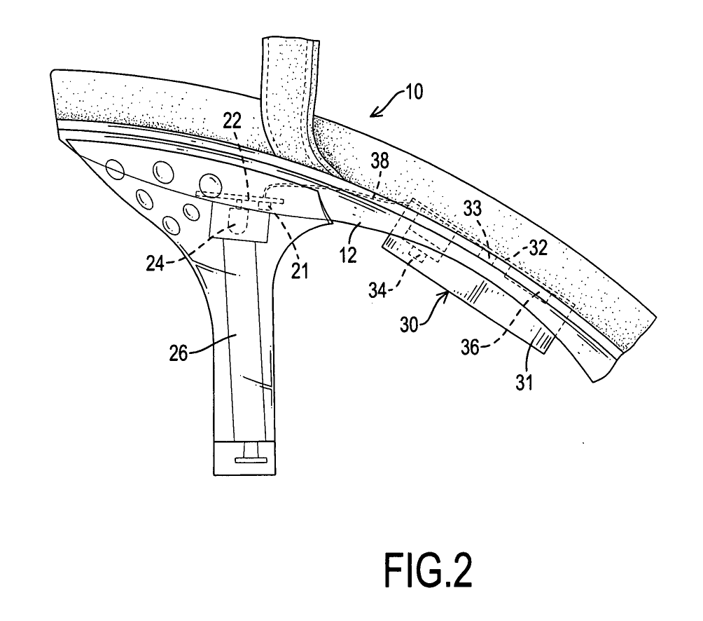

With reference to FIGS. 1 and 2, a shoe with an illuminating heel in accordance with the present invention comprises a shoe body (10), an illuminating device (20), a switch device (30) and a wire (38).

The shoe body (10) has a bottom face, a shank (12) and a heel (14). The heel (14) has a top and a bottom, is made of transparent material and is glued to the shoe body (10).

The illuminating device (20) is clamped between the bottom face of the shoe body (10) and the top of the heel (14) and comprises a circuit board (22), multiple illuminating elements (24) and an optional light conducting tube (26). The circuit board (22) is embedded in the bottom face of the shoe body (10) and has an integrated circuit (21). The integrated circuit (21) is mounted on the circuit board (22) to control the illuminating device (20), such as changing color, flashing, pulsing and the like. The illuminating elements (24) are attached electrically to the integrated circuit (21) through the circuit board (22), are mounted in the heel (14), preferably are different colored light emitting diodes (LEDs) and may be mounted on the circuit board (22) to show different colors. The light conducting tube (26) is embedded vertically inside the heel (14), extends to the bottom of the heel (14) and collects and transmits light emitted from the illuminating elements (24) to the bottom of the heel (14).

The switch device (30) is attached to the bottom face of the shoe body (10) at the shank (12) and has a circuit board (32), an integrated circuit (33), a switch (34), a power source (36) and a casing (31).

The circuit board (32) has a bottom face is embedded in the bottom face of the shoe body (10) at the shank (12).

The integrated circuit (33) is mounted on the circuit board (32).

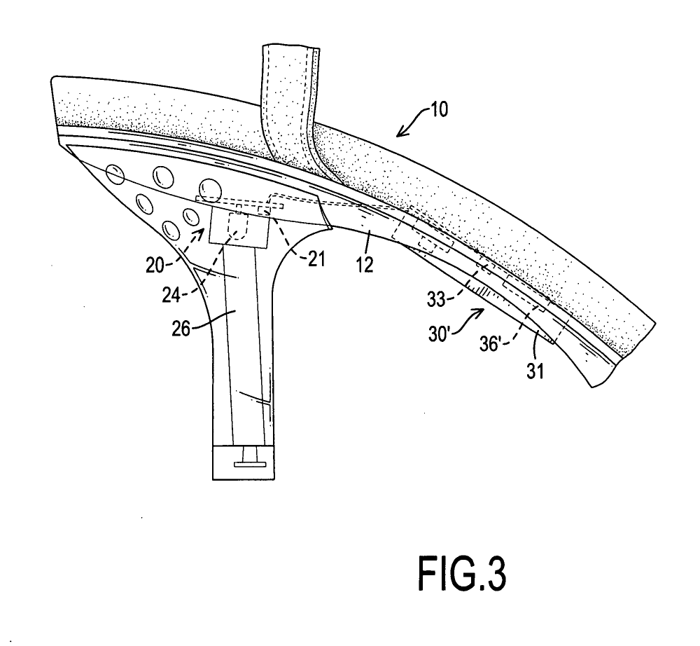

The switch (34) is mounted on the circuit board (32) and is connected to the integrated circuit (33). With further reference to FIG. 3, a second embodiment of the switch device (30′) has the switch (34) embedded in the shoe body (10) and electrically connected to the circuit board (32). The switch device (30′) is further minimized to totally embed in the shoe body (10) by possibly modifying the circuit board (32) to become thin or the power source to become small. The power source (36) is mounted on the circuit board (32). In the second embodiment of the power source is a low profile battery (36′).

The casing (31) is composed of a rectangular frame (312) and a cover (314). The rectangular frame (312) has a bottom opening, is mounted around and encloses the circuit board (32). The cover (314) is mounted pivotally on the rectangular frame (312) on the bottom opening. Therefore, the circuit board (32), the integrated circuit, the switch (34) and the power source (36) inside the casing (31) are accessible. Accordingly, replacing an exhausted power source (36) such as a battery with a new one is convenient and easy.

The wire (38) connects the circuit board (22) in the illuminating device (20) to the circuit board (32) in the switch device (30). The illuminating device (20) can be activated or deactivated or change modes of operation simply by pressing the switch (34) on the switch device (30). For example, pushing the switch (34) will cause the integrated circuit (33) in the switch device (30) to communicate with the integrated circuit (21) in the illuminating device (20) and turn on and operate the illuminating elements (24) in a prescribed mode. When the switch (34) is pushed again, the illuminating elements (24) turn off. However, pushing the switch (34) again will cause the integrated circuit in the switch device (30) to communicate with the integrated circuit in the illuminating device (20) that will turn on and operate the illuminating elements (24) in a different mode. With different colored lights emitted by the illuminating elements (24), numerous, versatile visual decorative effects can be provided. Consequently, the thin illuminating heel can provide a changeable illuminating decorative effect, and a shoe with the thin illuminating heel is attractive to consumers.

In the present invention, because the switch device (30) is separated from the illuminating device (20) in the heel (14) and particularly attached to the shank (12), the heel (14) can be greatly minimized in diameter to become thin. Therefore, the shoe can have the heel illuminating and thin features at the same time.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A shoe with an illuminating heel, the shoe comprising:
a shoe body (10) having
a bottom face;
a shank (12); and
a heel (14) made of transparent material and attached to the shoe body (10) and having
a top; and
a bottom;
an illuminating device (20) clamped between the bottom face of the shoe body (10) and the top of the heel (14) and comprising
a circuit board (22) embedded in the bottom face of the shoe body (10) and having an integrated circuit (21) mounted on the circuit board (22); and
multiple illuminating elements (24) mounted in the heel (14) and attached electrically to the integrated circuit (21) on the circuit board (22);
a switch device (30) attached to the bottom face of the shoe body (10) at the shank (12); and
a wire (38) electrically connecting the switch device (30) to the illuminating device (20) to control the illuminating device (20).

2. The shoe as claimed in claim 1, wherein
the switch device (30) comprises
a circuit board (32) having a bottom face and embedded inside the bottom face of the shoe body (10) at the shank (12);
an integrated circuit (33) mounted on the circuit board (32);
a switch (34) mounted on the circuit board (32) and connected to the integrated circuit (33) of the switch device (30); and
a power source (36) mounted on the circuit board (32) of the switch device (30);
a casing (31) composed of
a rectangular frame (312) having a bottom opening and mounted around and enclosing the circuit board (32); and
a cover (314) mounted pivotally on the rectangular frame (312) on the bottom opening;
wherein the circuit board (32), the switch (34) and the power source (36) are inside the casing (31); and
the wire (38) connects the circuit board (22) in the illuminating device (20) to the circuit board (32) in the switch device (30).

3. The shoe as claimed in claim 1, wherein the illuminating device (20) further has a light conducting tube (26) embedded vertically inside the heel (14) and extending to the bottom of the heel (14).

4. The shoe as claimed in claim 1, wherein the illuminating elements (20) are different colored light emitting diodes (LEDs) and are mounted on the circuit board (22).

5. The shoe as claimed in claim 1, wherein
the switch (34) of the switch device (30′) is embedded in the shoe body (10) and electrically connected to the circuit board (32); and
the power source is a low profile battery (36′).
